(19) United States
(12) Patent Application Publication
(10) Pub. No.: US 2025/0026664 A1
(43) Pub. Date: Jan. 23, 2025

(54) SYSTEMS AND METHODS OF REMOVING HALOGENATED COMPOUNDS FROM A CONTAMINATED SOURCE

(71) Applicant: NOBLIS, INC., Reston, VA (US)

(72) Inventors: Javier Mario Santillan, Garden Ridge, TX (US); Jovan Popovic, Carlsbad, CA (US)

(73) Assignee: NOBLIS, INC., Reston, VA (US)

(21) Appl. No.: 18/355,848

(22) Filed: Jul. 20, 2023

(51) Int. Cl. C02F 1/02; C02F 1/00; C02F 1/28; C02F 1/58

(52) U.S. Cl. CPC C02F 1/02; C02F 1/001; C02F 1/281; C02F 1/583; C02F 2101/36; C02F 2201/00

(57) ABSTRACT

Described herein are systems and methods for removing halogenated compounds from a contaminated source. These removal systems and methods include concentrating and removing halogenated compounds using select alkaline earth metal oxides, as well as acidifying and removing halogenated compounds using select acids.

### FIELD

The present disclosure relates to systems and methods for removing halogenated compounds from a contaminated source, and more specifically to systems and methods for removing select halogenated compounds by using select alkaline earth metal oxides to produce fluorinated salts.

### BACKGROUND

Halogenated compounds are a class of chemical substances that contain one or more halogen atoms, such as fluorine, chlorine, bromine, or iodine. These halogenated compounds have been widely utilized in industrial applications due to their useful properties, such as high thermal stability, low reactivity, and electrical insulation. A well-known example of halogenated compounds is per- and polyfluoroalkyl substances (PFAS), which include more than 3,000 chemicals, each of which is characterized by a strong carbon-fluoride bond. This carbon-fluoride bond allows many PFAS to be resistant to grease, oil, water, and heat. Thus, halogenated compounds such as PFAS have been used for decades in the production of stain-and water-resistant fabrics and carpeting, cleaning products, paints, cookware, food packaging, fire-fighting foams, and other such products.

However, concerns have emerged regarding the environmental and human health impacts associated with certain halogenated compounds such as PFAS. Because of their strong chemical bonds, many halogenated compounds have considerably long half-lives. For example, PFAS have earned the nickname “forever chemicals” due to their long half-lives and bioaccumulative nature. Because PFAS are so prevalent in commercial products and processes and their half-lives are so long, they have increasingly contaminated the environment over the years. This environmental contamination is especially concerning due to the adverse health effects attributed to PFAS, which can include kidney damage, immune system impairment, increased cholesterol levels, changes in liver enzymes, decreased vaccine response in children, low birth rates and birth defects, increased risk of some cancers, and reproductive issues, just to name a few.

### SUMMARY OF THE DISCLOSURE

As explained above, due to their commercially useful properties, halogenated compounds have been used for decades in numerous industries. Due to the high levels of environmental contamination and numerous adverse health effects attributed to these halogenated compounds, there is a need to find a method of treating contaminated sources to eliminate the halogenated compounds that have accumulated over the years. However, developing such methods has been particularly challenging due to the strong chemical bonds of halogenated compounds such as PFAS, which have a strong carbon-fluoride bond. These strong chemical bonds make it very difficult and energy-consuming to break down and remove halogenated compounds from the environment.

Accordingly, described herein are systems and methods for removing select halogenated compounds, such as PFAS, with alkaline earth metal oxides. These can include calcium oxide, which is known in the art, but can also include other oxides such as beryllium oxide, magnesium oxide, strontium oxide, barium oxide, or radium oxide. When one or more of the halogenated compounds reacts with the alkaline earth metal oxides in a furnace, the reaction produces one or more fluorinated salts and one or more heated gases. These products can be removed more easily than the halogenated compounds themselves. Furthermore, energy-conserving measures, such as using the heated gases left over in the furnace to provide heat energy to other components or acidifying the halogenated compounds to reduce the amount of heat energy required in the furnace, can reduce the amount of energy required to remove halogenated compounds from the environment. Thus, the systems and methods for removing halogenated compounds described herein achieve processes that effectively break down halogenated compounds in a more energy-efficient manner. The systems and methods provided herein can be used to treat contaminated sources, effectively removing the halogenated compounds to protect local communities from adverse health effects.

In some embodiments, described is a method for removing halogenated compounds from a contaminated source, the method comprising: concentrating one or more halogenated compounds of the contaminated source to achieve a concentrated source having a greater wt. % of halogenated compounds than the contaminated source; and removing the one or more halogenated compounds of the concentrated source by heating the concentrated source in the presence of beryllium oxide, magnesium oxide, strontium oxide, barium oxide, radium oxide, or any combination thereof to produce one or more fluorinated salts and one or more heated gases.

In some embodiments of the method, the contaminated source is a liquid source or a gaseous source. In some embodiments of the method, concentrating the one or more halogenated compounds of the contaminated source to achieve the concentrated source occurs in a continuous reactor.

In some embodiments of the method, the contaminated source is a solid source. In some embodiments of the method, concentrating the one or more halogenated compounds of the contaminated source to achieve the concentrated source occurs in a batch reactor.

In some embodiments of the method, the one or more halogenated compounds comprise per- and polyfluoroalkyl substances (PFAS), ethylene dibromide, chlorinated ethenes, chlorinated ethanes, halogenated methanes, freons, semi-volatile organic compounds, or any combination thereof.

In some embodiments of the method, concentrating the one or more halogenated compounds of the contaminated source comprises exposing the contaminated source to an ion exchange column comprising resin, granular activated carbons, absorbent compounds, or any combination thereof.

In some embodiments of the method, the concentrated source has greater than or equal to 0.01 wt. % halogenated compounds.

In some embodiments of the method, removing the one or more halogenated compounds of the concentrated source comprises heating the concentrated source to 200-900 degrees Celsius.

In some embodiments of the method, the one or more fluorinated salts comprise beryllium fluoride, magnesium fluoride, strontium fluoride, barium fluoride, radium fluoride, or any combination thereof.

In some embodiments of the method, the one or more heated gases comprise water vapor, nitrogen, carbon dioxide, or any combination thereof.

In some embodiments of the method, the method further comprises: heating the one or more halogenated compounds of the contaminated source with heat energy from the one or more heated gases.

In some embodiments of the method, the method further comprises: removing waste residues produced while heating the concentrated source. In some embodiments of the method, the waste residues comprise non-volatilized halogenated compounds, heavy organic molecules, salts, or any combination thereof.

In some embodiments, described is a system for removing halogenated compounds from a contaminated source, the system comprising: a concentration system comprising an inlet contaminated source comprising one or more halogenated compounds and an outlet concentrated source comprising the one or more halogenated compounds, wherein the outlet concentrated source has a halogenated compound concentration greater than that of the inlet contaminated source; and a furnace configured to receive the outlet concentrated source and heat the one or more halogenated compounds of the outlet concentrated source in the presence of beryllium oxide, magnesium oxide, strontium oxide, barium oxide, radium oxide, or any combination thereof to remove the one or more halogenated compounds and produce one or more fluorinated salts and one or more heated gases.

In some embodiments of the system, the contaminated source is a liquid source or a gaseous source. In some embodiments of the system, the concentration system comprises a continuous reactor for heating the inlet contaminated source.

In some embodiments of the system, the contaminated source is a solid source. In some embodiments of the system, the concentration system comprises a batch reactor for heating the inlet contaminated source.

In some embodiments of the system, the one or more halogenated compounds comprises per- and polyfluoroalkyl substances (PFAS), ethylene dibromide, chlorinated ethenes, chlorinated ethanes, halogenated methanes, freons, semi-volatile organic compounds, or any combination thereof.

In some embodiments of the system, the concentration system comprises an ion exchange column comprising resin, granular activated carbons, absorbent compounds, or any combination thereof.

In some embodiments of the system, the concentrated source has greater than or equal to 0.01 wt. % halogenated compounds.

In some embodiments of the system, the furnace is configured to heat the protonated source to 200-900 degrees Celsius.

In some embodiments of the system, the one or more fluorinated salts comprise beryllium fluoride, magnesium fluoride, strontium fluoride, barium fluoride, radium fluoride, or any combination thereof.

In some embodiments of the system, the one or more heated gases comprise water vapor, nitrogen, carbon dioxide, or any combination thereof.

In some embodiments of the system, the concentration system is configured to receive heat energy from the one or more heated gases from the furnace.

In some embodiments of the system, the system further comprises: a door for collecting and removing waste residues produced while heating the concentrated source. In some embodiments of the system, the waste residues comprise non-volatilized halogenated compounds, heavy organic molecules, salts, or any combination thereof.

In some embodiments, described is a method for removing halogenated compounds from a contaminated source, the method comprising: acidifying the one or more halogenated compounds of the contaminated source with an acid to achieve a protonated source having a pH less than 7; and removing the one or more halogenated compounds of the protonated source by heating the protonated source in the presence of one or more alkaline earth metal oxides to produce one or more fluorinated salts and one or more heated gases.

In some embodiments of the method, the protonated source has a pH of 6-6.5.

In some embodiments of the method, acidifying the one or more halogenated compounds comprises exposing the contaminated source to a gaseous supply of the acid.

In some embodiments of the method, the acid comprises hydrochloric acid, nitric acid, or any combination thereof.

In some embodiments, described is a system for removing halogenated compounds from a contaminated source, the system comprising: an acidification system configured to receive the contaminated source and acidify the one or more halogenated compounds of the contaminated source with an acid to produce a protonated source comprising the one or more halogenated compounds, wherein the protonated source has a pH less than that of the outlet concentrated source; and a furnace configured to receive the protonated source and heat the one or more halogenated compounds of the protonated source in the presence of one or more alkaline earth metal oxides to remove the one or more halogenated compounds and produce one or more fluorinated salts and one or more heated gases.

In some embodiments of the system, the acidification system further comprises: a tank for storing the acid; a pump for transporting the acid into a mixing chamber; a feed line for routing the acid from the tank into the pump; and an agitator for mixing the acid with the halogenated compounds of the contaminated source in the mixing chamber.

In some embodiments of the system, the protonated source has a pH of 6-6.5.

In some embodiments of the system, the acidification system is configured to expose the contaminated source to a gaseous supply of the acid.

In some embodiments of the system, the acid comprises hydrochloric acid, nitric acid, or any combination thereof.

### BRIEF DESCRIPTION OF THE FIGURES

FIG. 1 illustrates a system for removing halogenated compounds from a contaminated source, according to some embodiments;

FIG. 2 illustrates a subsystem for concentrating halogenated compounds and removing them from a contaminated source, according to some embodiments;

FIG. 3 illustrates a method for removing halogenated compounds from a contaminated source, according to some embodiments;

FIG. 4 illustrates a system for acidifying halogenated compounds and removing them from a contaminated source, according to some embodiments; and

FIG. 5 illustrates a method for acidifying halogenated compounds and removing them from a contaminated source, according to some embodiments.

### DETAILED DESCRIPTION OF THE DISCLOSURE

Described below are exemplary embodiments of systems and methods for removing halogenated compounds from a contaminated source using alkaline earth metal oxides. As explained above, due to their commercially useful properties, halogenated compounds have been used for decades in numerous industries. However, because halogenated compounds have long half-lives (due to their strong chemical bonds), they have leached into the environment and contaminated landfills, soils, and waterways for years. This is particularly concerting due to the adverse health risks associated with halogenated compounds. For example, exposure to PFAS, a well-known category of halogenated compounds, is associated with kidney damage, immune system impairment, increased cholesterol levels, changes in liver enzymes, decreased vaccine response in children, low birth rates and birth defects, increased risk of some cancers, and reproductive issues, just to name a few.

Many known systems and methods for removing halogenated compounds use high energy-consuming processes to break down halogenated compounds from the environment. However, the systems and methods described herein use alkaline earth metals to react with the halogenated compounds to produce fluorinated salts and heated gases, which can be removed more easily than the halogenated compounds themselves and may not contain any OSHA hazardous substances. Furthermore, the systems and methods described herein can use energy-conserving measures, such as using the heated gases to provide heat energy to other components or acidifying the halogenated compounds to reduce the amount of heat energy required for the reaction, to reduce the amount of energy required to remove halogenated compounds from the environment.

Accordingly, described herein are systems and methods for removing halogenated compounds from a contaminated source using alkaline earth metal oxides (e.g., beryllium oxide, calcium oxide, magnesium oxide, strontium oxide, barium oxide, radium oxide, or any combination thereof). When one or more of the halogenated compounds react with the alkaline earth metal oxides, the reaction produces one or more fluorinated salts (e.g., beryllium fluoride, calcium fluoride, magnesium fluoride, strontium fluoride, barium fluoride, radium fluoride, or any combination thereof) and one or more heated gases (e.g., water vapor, carbon dioxide, nitrogen, noble gases, or any combination thereof).

Contaminated sources, as used herein, may include any one or more of the following sources: surface water from natural bodies of water (e.g., creeks and rivers), groundwater, bilge water, landfill leachate, collected fire suppression foam (e.g., aqueous film-forming foam (AFFF)), ion exchange resins, regeneration waste streams, soil, sediments, absorbent compounds, fire suppressant compounds and equipment, or membrane process waste.

Halogenated compounds, as used herein, may include any one or more of the following substances: PFAS, ethylene dibromide (EDB), chlorinated ethenes (e.g., tetrachloroethene (PCE), trichloroethene (TCE), dichloroethene (DCE), and vinyl chloride (VC)), chlorinated ethanes (e.g., tetrachloroethane (PCA), trichloroethane (TCA), and dichloroethane (DCA)), halogenated methanes (e.g., methylene chloride), freons, or semi-volatile organic compounds (e.g., pesticides and herbicides).

PFAS, as used herein, may include any one or more of the following substances: AFFF, perfluorooctanoic acid (PFOA), perfluorooctanesulfonic acid (PFOS), GenX, perfluorobutane sulfonic acid (PFBS), perfluoropentanesulfonic acid (PFPS), perfluorohexane sulfonic acid (PFHxS), perfluoroheptanesulfonic acid PFHpS), perfluorononanesulfonic acid (PFNS), or perfluorodecanesulfonic acid (PFDS).

The contaminated source may be treated to remove other contaminants in the source prior to removing the halogenated compounds. This pretreatment may include, for example, separation methods, concentration methods, filtration methods (e.g., granulated activated carbon), or distillation methods, for removing excess water, soil, minerals, solvents, sediments, and/or debris from the contaminated stream. Pretreatment methods may also include dilution methods for diluting the concentration of halogenated compounds of a concentrated source to a suitable concentration for treatment (i.e., remove the halogenated compounds using select alkaline earth metal oxides). Pretreatment methods may also include acidification methods for protonating the halogenated compounds to reduce the amount of energy (i.e., heat energy from a furnace) required to break their chemical bonds.

The pretreated source comprising halogenated compounds can then be fed to a furnace comprising one or more alkaline earth metal oxides to remove the halogenated compounds from the source. The products of this removal process include one or more fluorinated salts and one or more gases. The fluorinated salts can be handled, packaged, and disposed of according to their chemical disposal guidelines, with proper precautions taken to ensure safety. The gases, which can include water vapor, carbon dioxide, nitrogen, or noble gases, can be safely released into the atmosphere. In some embodiments, an energy regeneration or energy conversion method can be performed to reuse heat energy from the gases. Heat energy from the gases that would otherwise be released into the atmosphere as waste energy can instead be reused to provide heat energy to halogenated compounds earlier in the process (e.g., during pretreatment), thereby reducing the amount of additional heat energy required to perform the pretreatment methods described above.

Described below are systems and methods for removing halogenated compounds from a contaminated source. These removal systems and methods include concentrating and removing halogenated compounds, as well as acidifying and removing halogenated compounds. Each is described in detail below.

### Systems and Methods for Concentrating and Removing Halogenated Compounds from a Contaminated Source

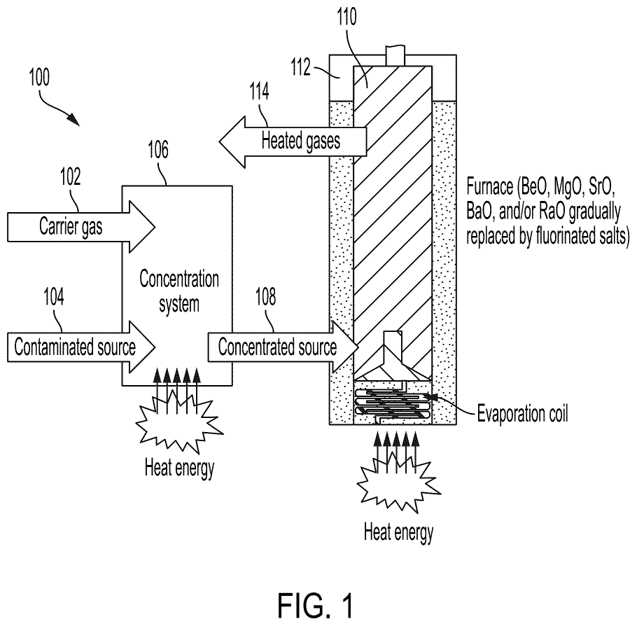

Described herein are systems for removing halogenated compounds from a contaminated source by treating the halogenated compounds of the contaminated source with beryllium oxide, magnesium oxide, strontium oxide, barium oxide, radium oxide, or any combination thereof to produce one or more fluorinated salts and one or more heated gases (referred to herein as “treating,” “treatment,” “removal treatment,” and variations thereof). In some embodiments, systems for removing halogenated compounds may include a concentration system for concentrating the halogenated compounds of the contaminated source to form a concentrated source, which may then be treated to remove the halogenated compounds. For example, FIG. 1, which is described in detail below, depicts a system for removing halogenated compounds from a concentrated source (i.e., an input stream having a concentration of halogenated compounds suitable for removal treatment). Halogenated compounds are first heated within a concentration system (e.g., an ion exchange column) to extract a concentrated source of halogenated compounds, then heated again within a furnace (e.g., a reaction chamber) to convert the halogenated compounds into a more easily removable form. Because the halogenated compounds of the concentrated source are present in a greater concentration than the contaminated source, they can be converted to fluorinated salts and/or heated gases, then removed, more quickly and effectively than if they were to remain in the contaminated source of a lower concentration.

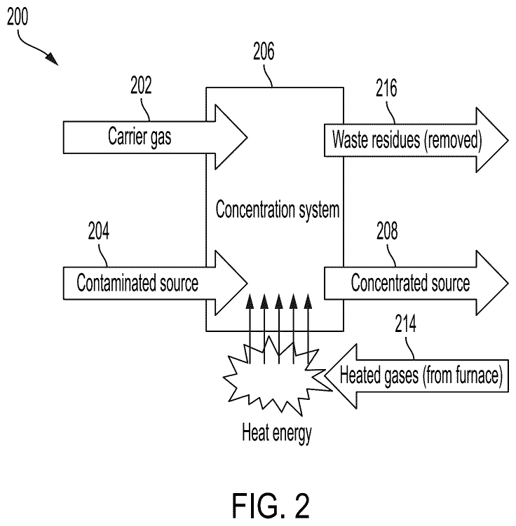

FIG. 1 illustrates a system 100 for removing halogenated compounds from a contaminated source 104, according to some embodiments. As shown in FIG. 1, the halogenated compounds originate from the contaminated source 104, enter a concentration system 106, undergo a concentration method to become part of a concentrated source 108. enter a furnace 112, and react with select alkaline earth metal oxides 110 to produce heated gases 114 and fluorinated salts. Heat energy may be applied to the concentration system 106 and/or the furnace 112 to produce the desired chemical reactions. In some embodiments, heat energy formed in furnace 112 may be applied to the concentration system 106 to produce the desired outcome (see FIG. 2 for more details).

The concentration system 106 is configured to concentrate the halogenated compounds of contaminated source 104 to achieve a concentrated source 108 having a halogenated compound concentration suitable for removal treatment. In some embodiments, the concentration system 106 may include one or more of a filtration process, ion exchange process, distillation process, a chromatography process, an evaporation process, an extraction process, a heating process, a solvent extraction process, and/or a concentration process. As shown in FIG. 1, the input streams of concentration system 106 can include a carrier gas 102. a contaminated source 104, and heat energy, among other inputs. The output streams of concentration system 106 can include a concentrated source 108, among other outputs.

As shown in FIG. 1, in order to transport the halogenated compounds of the contaminated source 104 through the concentration system 106, the concentration system 106 receives the carrier gas 102 as an input stream. In some embodiments, the carrier gas 102 may be air, helium gas, nitrogen gas, argon gas, another noble gas, or any combination thereof. The carrier gas 102 serves as a transportation medium and does not chemically react with other compounds involved in concentrating and/or removing the halogenated compounds.

As shown in FIG. 1, another input stream received by the concentration system 106 is the contaminated source 104. In some embodiments, the contaminated source 104 may contain one or more halogenated compounds from a variety of environmental or artificial sources. The concentration method performed by the concentration system 106 may vary depending on the composition of the contaminated source 104 (e.g., solid, salt, liquid, gas) and/or the concentration of halogenated compounds present in the contaminated source 104 before pretreatment. For example, in some areas, the halogenated compound AFFF may be collected and contained in stockpiles. If the contaminated source 104 is obtained from these stockpiles, the concentration of AFFF in the contaminated source 104 may be sufficiently high such that the AFFF requires minimal to no additional concentration in the concentration system 106. Accordingly, in some embodiments, the contaminated source 104 may bypass the concentration system 106 entirely and directly enter the furnace 112. Alternatively, in some areas, such as a residential water source, halogenated compounds may be distributed more sparsely. If the contaminated source 104 is obtained from these residential water sources, the concentration of halogenated compounds in the contaminated source 104 may be low, and they may be concentrated in the concentration system 106.

In some embodiments, the concentration of the contaminated source 104 is 1×10⁻⁷ to 5×10⁻³ wt. % halogenated compounds. In some embodiments, the concentration of the contaminated source 104 is less than or equal to 5×10⁻³, 1×10⁻³, 1×10⁻⁴, 1×10⁻⁵, or 1×10⁶ wt. % halogenated compounds. In some embodiments, the concentration of the contaminated source 104 is greater than or equal to 1×10⁻⁷, 1×10⁻⁶, 1×10⁻⁵, 1×10⁻⁴, or 1×10⁻³ wt. % halogenated compounds. In some embodiments, the concentration of the contaminated source 104 is 0.01-1, 0.1-10, 1-8, or 1-5 wt. % halogenated compounds. In some embodiments, the concentration of the contaminated source 104 is less than or equal to 10, 9, 8, 7, 6, 5, 4, 3, 2, 1, or 0.5 wt. % halogenated compounds. In some embodiments, the concentration of the contaminated source 104 is greater than or equal to 0.01. 0.1, 0.5, 1, 2, 3, 4, 5, 6, 7, 8, or 9 wt. % halogenated compounds.

As shown in FIG. 1, the concentration system 106 may receive heat energy as an input to produce the desired chemical reactions. In some embodiments, the concentration system 106 may be an ion exchange column. The ion exchange column may include one or more resins, which is depleted in a chemical reaction when concentrating the halogenated compounds and restored by a regeneration substance. In some embodiments, methanol may be used as a regeneration substance to regenerate the resin and remove the halogenated compounds from the resin. In some embodiments, the ion exchange column may comprise other resins, granular activated carbons, absorbent compounds, or any combination thereof.

In some embodiments, the concentration system 106 may include one, two, three, four, or more ion exchange columns. In some embodiments, two or more ion exchange columns may be connected in series or in parallel. In some embodiments, three or more ion exchange columns may be connected in a combination of series and parallel. A three-way or multi-way valve may connect ion exchange units, allowing for the selection of one, two, or multiple ion exchange units.

For example, for a concentration system comprising one resin-based ion exchange column (e.g., concentration system 106), the concentration system may receive at least two input streams: a contaminated source (e.g., contaminated source 104) containing halogenated compounds to react with the resin, and a regeneration substance stream containing compounds to regenerate the resin. A carrier gas (e.g., carrier gas 102) may also be an input stream, as described previously. In this example, from the reaction of the halogenated compounds with the resin, the concentration system may produce at least two output streams: a halogenated compound-free effluent stream and a halogenated compound-regeneration substance stream. (Compounds from the carrier gas may be found in any of the output streams, but these carrier gas compounds may be inert and do not play a major role in any reactions involving the halogenated compounds.) The halogenated compound-free effluent output stream is formed after the halogenated compounds of the contaminated source exchange with components of the resin. This effluent output stream may be released to the atmosphere. The halogenated compound-regeneration substance output stream is formed after the regeneration of the resin and may contain a higher concentration (e.g., wt. %) of halogenated compounds than the original contaminated source. This output stream may be further processed to form a concentrated source (e.g., concentrated source 108).

In the above example, the further processing of the halogenated compound-regeneration substance output stream may include distilling and/or diluting the output stream. This processing may occur within the concentration system, or it may occur in one or more separate systems, for example, a distillation system and a dilution system. The regeneration substance of the output stream (e.g., methanol) may be distilled to concentrate the halogenated compounds. If necessary, the output stream may then be diluted to adjust the halogenated compounds to a suitable concentration. A concentrated source (e.g., concentrated source 108) may be formed after the halogenated compound-regeneration substance output stream has been processed by a distillation system and/or a dilution system.

Referring again to FIG. 1, the concentrated source 108 leaves the concentration system 106 as an output stream. In some embodiments, the concentrated source 108 may include any or all of the features of the contaminated source 104 described above. For example, concentrated source 108 may have a concentration of 0.01-1, 0.1-10, 1-8, or 1-5 wt. % halogenated compounds. In some embodiments, the concentration of concentrated stream 108 is less than or equal to 10, 9. 8, 7, 6, 5, 4, 3, 2, 1, or 0.5 wt. % halogenated compounds. In some embodiments, the concentration of concentrated stream 108 is greater than or equal to 0.01. 0.1, 0.5, 1, 2, 3, 4, 5, 6, 7, 8, or 9 wt. % halogenated compounds. In some embodiments, the concentrated source 108 may have a greater wt. % of halogenated compounds than the contaminated source 104.

In some embodiments, such as embodiments in which the contaminated source 104 is a solid source, concentration system 106 may include a batch process that is performed in a batch reactor. In some embodiments, such as embodiments in which contaminated source 104 is a liquid or gaseous source, concentration system 106 may include a continuous process that is performed in a continuous reactor. In some embodiments of a batch process, concentration system 106 may be configured to process contaminated source 104 in quantities of 0.1-1,000, 50-500, or 100-500 L. In some embodiments, concentration system 106 may be configured to process contaminated source 104 in quantities of less than or equal to 1,000, 900, 800, 700, 600, 500, 400, 300, 200, 100, 50, 10, 11, or 0.5 L. In some embodiments, concentration system 106 may be configured to process contaminated source 104 in quantities of greater than or equal to 0.1, 0.5, 1, 10, 50, 100, 200, 300, 400, 500, 600, 700, 800, or 900 L.

In some embodiments of a continuous process, contaminated source 104 may enter concentration system 106 at flow rates of 2 to 20 gallons per minute (GPM) per ion exchange unit. In some embodiments, contaminated source 104 may enter concentration system 106 at flow rates of less than or equal to 20, 19, 18, 17. 16, 15, 14, 13, 12, 11, 10, 9, 8, 7, 6, 5, 4, or 3 GPM per ion exchange unit. In some embodiments, contaminated source 104 may enter concentration system 106 at flow rates of greater than or equal to 2, 3, 4, 5, 6, 7, 8, 9, 10, 11, 12, 13, 14, 15, 16, 17, 18, or 19 GPM per ion exchange unit.

As shown in FIG. 1, the furnace 112 receives the concentrated source 108 as an input stream. In some embodiments, the furnace 112 is configured to heat the concentrated source 108, allowing one or more halogenated compounds of the concentrated source 108 to react with select alkaline earth metal oxides 110. After reacting, the select alkaline earth metal oxides 110 of the furnace 112 are gradually replaced with one or more fluorinated salts. Periodically, the select alkaline earth metal oxides 110 will need to be replaced. The output streams of furnace 112 can include heated gases 114 and the fluorinated salts, among other outputs.

In some embodiments, the furnace 112 may be a muffle furnace. The furnace 112 may also be any kiln or heated oven. In some embodiments, the system 100 may comprise a single furnace 112. In some embodiments, the system 100 may comprise more than one furnace 112, such as two, three, four, five, six, or more furnaces 112. In some embodiments, two or more furnaces 112 may be connected in series. In some embodiments, two or more furnaces 112 may be connected in parallel. In some embodiments, three or more furnaces 112 may be connected in a combination of series and parallel. A three-way or multi-way valve may connect furnace units, allowing for the selection of one, two, or multiple furnace units.

The furnace 112 comprises select alkaline earth metal oxides 110, such as beryllium oxide, magnesium oxide, strontium oxide, barium oxide, radium oxide, or any combination thereof, in cartridge form. In some embodiments, the cartridge may include pellets that allow for a fast and easy flow. However, a cartridge comprising pellets of select alkaline earth metal oxides 110 exclusively may result in an imperfect reaction with the halogenated compounds (e.g., 90% completion). Thus, in some embodiments, the cartridge may include pellets of select alkaline earth metal oxides 110 mixed with silica sand. The pellets mixed with silica sand may significantly increase the reactive surface area while still exhibiting an acceptable flow rate (e.g., 1-4 cubic feet per minute through a 4-inch inside diameter cartridge).

As described above, halogenated compounds can react with select alkaline earth metal oxides 110 under certain conditions to produce water, carbon dioxide, and fluorinated salts. For example, Table 1 below illustrates reactants and products of a complete reaction involving the reaction of perfluorooctanoic acid (C₈HF₁₅O₂), a halogenated compound, and magnesium oxide (MgO), an alkaline earth metal oxide, within the furnace 112.

TABLE 1

| Reactants | | | | Products | | |
|---|---|---|---|---|---|---|
| 2 C₈HF₁₅O₂ | 15 MgO | 7 O₂ | → | 15 MgF₂ | 16 CO₂ | 1 H₂O |

In some embodiments, the reaction of halogenated compounds and the select alkaline earth metal oxides 110 in the furnace 112 may run to 80-100%, 85-99%, 90-99%, or 90-95% completion. In some embodiments, the reaction may run to less than or equal to 100%, 99%, 95%, 90%, or 85% completion. In some embodiments, the reaction may run to greater than or equal to 80%, 85%, 90%, 95%, or 99% completion.

In some embodiments, to effectively cause the halogenated compounds of the concentrated source 108 and the select alkaline earth metal oxides 110 to react, the furnace 112 may be heated to 200-900, 200-1,500, 400-1,000, or 500-800 degrees Celsius. In some embodiments, the furnace 112 may be heated to less than or equal to 1,500, 1,200, 1,000, 800, 600, 500, 400, or 300 degrees Celsius. In some embodiments, the furnace 112 may be heated to greater than or equal to 200, 300, 400, 500, 600, 800, 1,000, or 1,200 degrees Celsius. In some embodiments, the furnace 112 may comprise heating coils and/or evaporation coils to maintain the desired temperature throughout the duration of the reaction.

In some embodiments, the halogenated carbons may be heated at a first temperature in the concentration system 106 and again at a second temperature in the furnace 112. In some embodiments, the first temperature may be lower than the second temperature. In some embodiments, the first temperature could be the same temperature or higher than the second temperature. The first and second temperatures may be any range of temperatures described above.

As shown in FIG. 1, the reaction of halogenated compounds with select alkaline earth metal oxides 110 within the furnace 112 produces fluorinated salts, which gradually replace the select alkaline earth metal oxides 110 of the cartridge (i.e., mineralization). Once the cartridge is depleted, it can be removed and replaced with a different cartridge. Other products of the reaction (i.e., water vapor, carbon dioxide, nitrogen, and/or noble gases from the carrier gas 102) are released from the furnace 112 as heated gases 114. In some embodiments, the reaction may occur at atmospheric pressure. In some embodiments, these products may be released into the atmosphere and/or stored in a tank. In some embodiments, the carbon dioxide may be bubbled through a calcium hydroxide solution to capture the carbon dioxide and avoid the release of greenhouse gases. In some embodiments, about 0.25 pounds of carbon dioxide may be generated for each pound of the halogenated compounds mineralized. In some embodiments, about 66 liters of carbon dioxide may generated at 25° C. per pound of the halogenated compounds mineralized.

In some embodiments, the furnace 112 may include a batch process. In some embodiments, the furnace 112 may include a continuous process. In some embodiments of a batch process, the furnace 112 may be configured to process the concentrated source 108 in quantities of 0.1-1,000, 50-500, or 100-500 L. In some embodiments, the furnace 112 may be configured to process the concentrated source 108 in quantities of less than or equal to 1,000, 900, 800, 700, 600, 500, 400, 300, 200, 100, 50, 10, 1, or 0.5 L. In some embodiments, the furnace 112 may be configured to process the concentrated source 108 in quantities of greater than or equal to 0.1, 0.5, 1, 10, 50, 100, 200, 300, 400, 500, 600, 700, 800, or 900 L.

In some embodiments of a continuous process, the concentrated source 108 may enter the furnace 112 at flow rates of 0.1 to 10 or 2 to 5 gallons per minute (GPM) per furnace unit. In some embodiments, the concentrated source 108 may enter the furnace 112 at flow rates less than or equal to 10, 9, 8, 7, 6, 5, 4, 3, 2, 1, or 0.5 GPM per furnace unit. In some embodiments, the concentrated source 108 may enter the furnace 112 at flow rates greater than or equal to 0.1, 0.5, 1, 2, 3, 4, 5, 6, 7, 8, or 9 GPM per furnace unit.

Described herein are additional components of a system for concentrating and removing halogenated compounds from a contaminated source. For example, FIG. 2 illustrates a subsystem 200, centered around concentration system 206 that includes additional components and may be used in place of concentration system 106 of FIG. 1. As shown in the figure, the concentration system 206 may produce removable waste residues 216 as an output of the concentration process. Heated gases 214, which may include any features of heated gases 114 from FIG. 1, from the furnace may be used to provide additional heat energy to the concentration system 206, thereby reusing some portion of the heat energy required to perform the concentration process.

As shown in FIG. 2, the waste residues 216 may be removed from the concentration system 206. In some embodiments, waste residues 216 may include non-volatilized halogenated compounds, heavy organic molecules, salts, or any combination thereof that are produced when heating the contaminated source 204. In some embodiments, such as embodiments in which the waste residues 216 are a solid source, the waste residues may be swept, brushed, or otherwise removed from a chamber of the concentration system 206 and processed accordingly. A door or other opening on the surface of the concentration system 206 may be used to access the inside of the concentration system 206 in which the waste residues 216 may accumulate. Waste residues 216 may be removed on a regular basis to preserve the functionality and efficiency of the concentration system 206.

As shown in FIG. 2, the heated gases 214 from a furnace (e.g., furnace 112 of FIG. 1) may be used to provide additional heat energy to the concentration system 206, thereby reusing some portion of the heat energy required to perform the concentration process. In some embodiments, the heated gases 214 may be produced from the reaction between halogenated compounds and select alkaline earth metal oxides (e.g., select alkaline earth metal oxides 110 of FIG. 1). Instead of releasing the heated gases 214, which can include water vapor, carbon dioxide, nitrogen, or noble gases, into the atmosphere, an energy regeneration or energy conversion method can be performed to reuse heat energy from the gases. Heat energy from the heated gases 214 can instead be reused to provide heat energy to halogenated compounds in the concentration system 206, thereby reducing the amount of additional heat energy required to complete the concentration process.

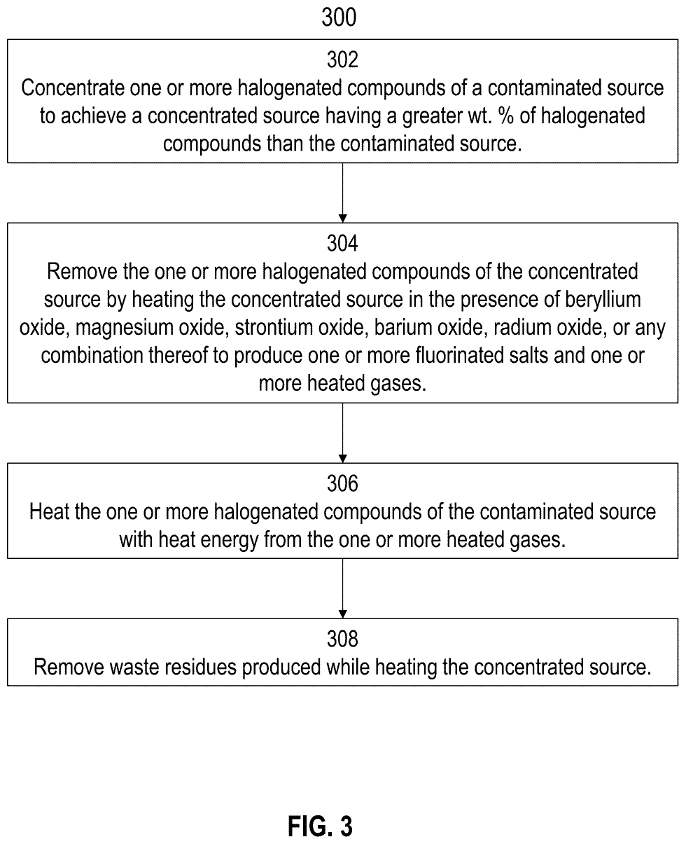

Also described herein are methods of concentrating and removing halogenated compounds from a contaminated source. For example, FIG. 3 illustrates a method 300 of removing one or more halogenated compounds from a contaminated source, according to some embodiments. Described below are methods that include concentrating (i.e., separating) one or more halogenated compounds from a contaminated source to achieve a concentrated source (i.e., at step 302), removing the one or more halogenated compounds from the concentrated source (i.e., at step 304), heating the contaminated source with excess heat energy produced during the removal process (i.e., at step 306), and/or removing waste residues produced during the concentration process (i.e., at step 308). Any one of the steps described below may be optional.

At step 302, method 300 includes concentrating one or more halogenated compounds of a contaminated source (e.g., contaminated source 104 of FIG. 1) to achieve a concentrated source (e.g., concentrated source 108 of FIG. 1). For example, the contaminated source may be routed through a concentration system (e.g., concentration system 106 of FIG. 1). In some embodiments, the concentrated source may have a greater wt. % of halogenated compounds than the contaminated source.

At step 304, method 300 includes removing the one or more halogenated compounds of the concentrated source by heating it in the presence of select alkaline metal oxides (e.g., beryllium oxide, magnesium oxide, strontium oxide, barium oxide, radium oxide, or any combination thereof; select alkaline metal oxides 110 of FIG. 1) to produce one or more fluorinated salts and one or more heated gases. The concentrated source may be treated by a removal system (e.g., furnace 112 of FIG. 1). For example, the halogenated compounds of the concentrated source may be removed by heating the concentrated source in the presence of magnesium oxide, producing magnesium fluoride, water, and carbon dioxide. If the concentration step (i.e., step 302) is omitted, step 304 may be performed directly with the contaminated source instead of the concentrated source.

At step 306, method 300 includes heating the one or more halogenated compounds of the contaminated source during the concentration step (i.e., step 302) with heat energy from the one or more heated gases produced during the removal step (i.e., step 304). This redirected heat energy may be in addition to heat energy already applied to the concentration system in step 302. If the redirecting heat step (i.e., step 306) is omitted, the heat energy from the one or more heated gases will not be used in step 302.

At step 308, method 300 includes removing waste residues produced while heating the contaminated source during the concentration step (i.e., step 302). For example, salts left behind in the concentration system may be removed by a brush. In some embodiments, waste residues produced while heating the concentrated source during the removal step (i.e., step 304) may also be removed. For example, salts that have replaced a magnesium oxide cartridge may be removed by replacing the cartridge. If the cleaning step (i.e., step 308) is omitted, the waste residues will not be removed as part of method 300.

### Systems and Methods for Acidifying and Removing Halogenated Compounds from a Contaminated Source

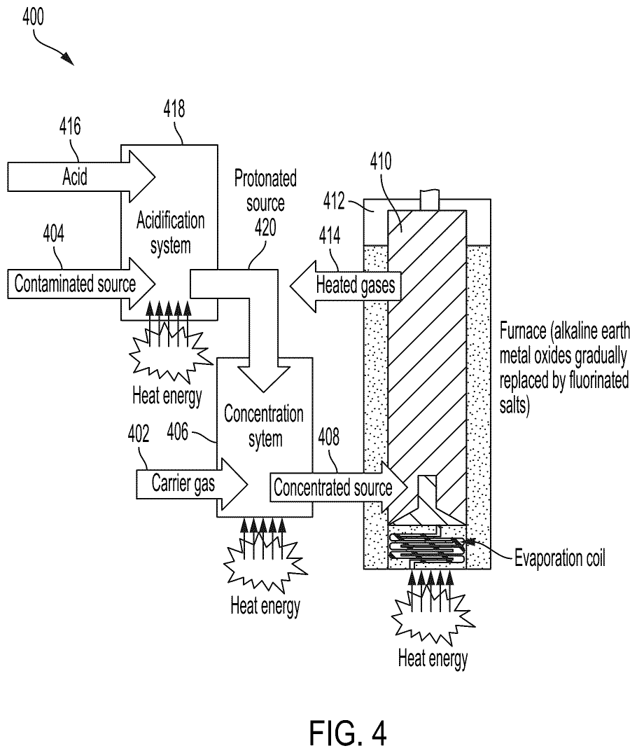

In some embodiments, systems for removing halogenated compounds may include an acidification system for acidifying the halogenated compounds of the contaminated source to form a protonated source, which may then be treated to remove the halogenated compounds. Acidification, which reduces the amount of energy required to volatilize the halogenated compounds, enables more energy-efficient volatilization of the halogenated compounds. For example, FIG. 4, which is described in detail below, depicts a system for removing halogenated compounds from a protonated source (i.e., an input stream having a pH less than 7). Halogenated compounds from a contaminated source are combined with acid within an acidification system (e.g., a mixing chamber) to produce a protonated source of halogenated compounds, then heated within a furnace (e.g., a reaction chamber) to convert the halogenated compounds into a more easily removable form. Because the halogenated compounds of the protonated source have different physical properties after undergoing acidification, they can be converted to metallic fluorinated salts and/or heated gases, then removed, at lower temperatures than if they were to remain in the non-acidified contaminated source. (In the environment, some halogenated compound pollutants exist as anions, which often require higher temperatures for reaction.) This reduces the amount of heat energy required in the furnace and can thus reduce the amount of energy required to remove halogenated compounds from the environment.

FIG. 4 illustrates a system 400 for removing halogenated compounds from a contaminated source 404, according to some embodiments. As shown in FIG. 4, the halogenated compounds originate from the contaminated source 404, enter an acidification system 418, undergo a method to be volatilized and become part of a protonated source 420, enter a concentration system 406, undergo a concentration method to become part of a concentrated source 408, enter a furnace 412, and react with alkaline earth metal oxides 410 to produce heated gases 414 and fluorinated salts of the metal oxide. Protonation, as used herein, refers to a molecule (e.g., a halogenated compound) exchanging a cation with an H+ion to become more acidic.

As shown in FIG. 4, the contaminated source 404 enters the acidification system 418 as an input stream. The acidification system 418 is configured to acidify and volatilize the halogenated compounds of contaminated source 404 to achieve a protonated source 420. In some embodiments, the acidification system 418 may be configured to mix the contaminated source 404 with an acid 416, allowing the one or more halogenated compounds of the contaminated source 404 to protonate. The input streams of acidification system 418 can include the contaminated source 404 and the acid 416, among other inputs (e.g., heat energy). The output streams of acidification system 418 can include a protonated source 420 and a salt, among other outputs. In some embodiments, acidification system 418 may include a batch process similar to the processes described for concentration system 106 of FIG. 1. In some embodiments, acidification system 418 may include a continuous process similar to the processes described for concentration system 106 of FIG. 1. The acidification/protonation method performed by the acidification system 418 may vary depending on the composition of the contaminated source 404 (e.g., solid, salt, liquid, gas) and/or the concentration of halogenated compounds present in the concentrated source 408.

As shown in FIG. 4, the acidification system 418 may receive acid 416 and contaminated source 404 as reactants to produce the desired protonation reaction. In some embodiments, acid 416 may include one or more of a strong acid such as hydrochloric acid (HCl) or nitric acid (HNO₃). Acid 416 may be dilute. Acid 416 can be stored, handled, packaged, and disposed of according to its chemical handling guidelines, with proper precautions taken to ensure safety. Acid 416 may be injected into the acidification system 418 in liquid or gaseous form. In some embodiments, acid 416 can be injected in a sufficient quantity or at a sufficient rate to react partially or completely with the quantity or rate of contaminated source 404 that is injected into the acidification system. These quantities can be determined by titrating a sample of the contaminated source 404 with a sample of the acid 416, measuring changes in pH during the titration reaction, then calculating the amount of acid 416 required to change the pH of a given quantity of contaminated source 404 by a given amount.

The acidification system 418 may comprise various components to receive, mix, store, and expel the halogenated compounds and other compounds. For example, the acidification system 418 may include a tank for storing the acid 416, a mixing chamber for reacting the acid 416 with the halogenated compounds of the contaminated source 404, a pump (such as a peristaltic pump) to control backflow and add the desired quantity of acid 416 to the mixing chamber, an agitator for mixing the acid 416 and the halogenated compounds of the contaminated source 404 in the mixing chamber, and any feed lines (such as a feed line for routing the acid 416 from the tank to the pump) necessary to transport the acid 416, the contaminated source 404, the protonated source 420, or any other inputs and outputs of the acidification system 418.

As described above, halogenated compounds can react with one or more acids 416 under certain conditions to become protonated (i.e., gain an additional H+ ion to become more acidic). For example, Table 2 below illustrates reactants and products of a complete reaction involving the reactions of sodium perfluorooctane (C₈NaF₁₅O₂), a halogenated compound and the precursor to perfluorooctanoic acid (C₈HF₁₅O₂), with hydrochloric acid (HCl) or nitric acid (HNO₃) within the acidification system 418.

TABLE 2

| | |
|---|---|
| Reactants | Products |

| | | | | |
|---|---|---|---|---|
| 1 C₈NaF₁₅O₂ | 1 HCl | → | 1 C₈HF₁₅O₂ | 1 NaCl |
| 1 C₈NaF₁₅O₂ | 1 HNO₃ | → | 1 C₈HF₁₅O₂ | 1 NaNO₃ |

Referring again to FIG. 4, the acidification system 418 may produce protonated source 420 as a product of the protonation reaction between acid 416 and the halogenated compounds of contaminated source 404. In some embodiments, protonated source 420 comprises one or more halogenated compounds that have been protonated. The pH of the protonated source 420 may be less than 7, and ideally ranges between 6 and 6.5. A protonated source 420 of a very low pH may degrade the furnace 412 and its cartridge containing alkaline earth metal oxides 410, while one of an insufficiently low pH may not have a lower boiling point than the contaminated source 404 and thus would not provide any improvements to the reduction of heat energy required in the reaction within furnace 412.

Heat energy may be applied to the concentration system 406, the acidification system 418, and/or the furnace 412 to produce the desired chemical reactions. In some embodiments, to effectively protonate the halogenated compounds of the concentrated source 408, the acidification system 418 may be heated to 200-900, 200-1,500, 400-1,000, or 500-800 degrees Celsius. In some embodiments, the acidification system 418 may be heated to less than or equal to 1,500, 1,200, 1,000, 800, 600, 500, 400, or 300 degrees Celsius. In some embodiments, the acidification system 418 may be heated to greater than or equal to 200, 300, 400, 500, 600, 800, 1,000, or 1,200 degrees Celsius.

As shown in FIG. 4, the concentration system 406 is configured to receive protonated source 420. The concentration system 406 can concentrate the halogenated compounds of protonated source 420 to achieve a concentrated source 408 having a halogenated compound concentration suitable for removal treatment. In some embodiments, the concentration system 406 may include one or more of a filtration process, ion exchange process, distillation process, a chromatography process, an evaporation process, an extraction process, a heating process, a solvent extraction process, and/or a concentration process. As shown in FIG. 4, the input streams of concentration system 406 can include a carrier gas 402, a protonated source 420, and heat energy, among other inputs. The output streams of concentration system 406 can include a concentrated source 408, among other outputs.

The devices, systems, inputs, outputs, and other components associated with concentration system 406 can share any features of concentration system 106 of FIG. 1. For example, carrier gas 402 can share any features of carrier gas 102, contaminated source 404 can share any features of contaminated source 104, concentration system 406 can share any features of concentration system 106, and/or concentrated source 408 can share any features of concentrated source 108 of FIG. 1.

As shown in FIG. 4, the furnace 412 receives the concentrated source 408 as an input stream. In some embodiments, the furnace 412 is configured to heat the concentrated source 408, allowing one or more halogenated compounds of the concentrated source 408 to react with alkaline earth metal oxides 410. After reacting, the alkaline earth metal oxides 410 of the furnace 412 are gradually replaced with one or more fluorinated salts. Periodically, the alkaline earth metal oxides 410 will need to be replaced or regenerated. The output streams of furnace 412 can include heated gases 414 and the fluorinated salts, among other outputs. In some embodiments, such as if the concentration method is omitted, the furnace 412 may be configured to heat the contaminated source 404 or the protonated source 420 instead of the concentrated source 408.

The devices, systems, inputs, outputs, and other components associated with furnace 412 can share any features of furnace 112 of FIG. 1. For example, the input stream (e.g., concentrated source 408) can share any features of the input stream (e.g., concentrated source 108), alkaline earth metal oxides 410 can share any features of the select alkaline earth metal oxides 110 and further include calcium oxide on the list of alkaline earth metal oxides available, furnace 412 can share any features of furnace 112, and/or heated gases 414 can share any features of heated gases 114 of FIG. 1.

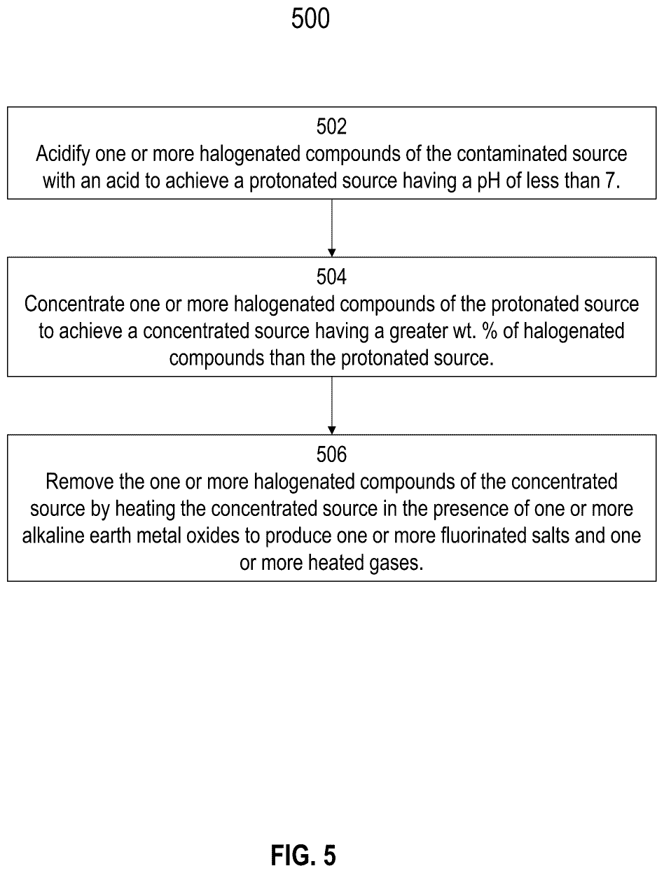

Also described herein are methods of acidifying and removing halogenated compounds from a contaminated source. For example, FIG. 5 illustrates a method 500 of removing one or more halogenated compounds from a contaminated source, according to some embodiments. Described below are methods that include acidifying (i.e., protonating) the one or more halogenated compounds from the concentrated source to achieve a protonated source (i.e., at step 502), concentrating one or more halogenated compounds from a contaminated source to achieve a concentrated source (i.e., at step 504), and removing the one or more halogenated compounds from the protonated source (i.e., at step 506). Any one of the steps described below may be optional.

At step 502, method 500 includes acidifying the one or more halogenated compounds of the concentrated source with an acid (e.g., acid 416 of FIG. 4) to achieve a protonated source (e.g., protonated source 420 of FIG. 4). For example, the concentrated source may be routed through an acidification system (e.g., acidification system 418 of FIG. 4). In some embodiments, the protonated source may have a pH of less than 7 (i.e., is acidic).

At step 504, method 500 includes concentrating one or more halogenated compounds of a protonated source (e.g., protonated source 420 of FIG. 4) to achieve a concentrated source (e.g., concentrated source 408 of FIG. 4). For example, the contaminated source may be routed through a concentration system (e.g., concentration system 406 of FIG. 4). In some embodiments, the concentrated source may have a greater wt. % of halogenated compounds than the protonated source. If the acidification step (i.e., step 502) is omitted, step 504 may be performed directly with the contaminated source instead of the protonated source.

At step 506, method 500 includes removing the one or more halogenated compounds of the concentrated source by heating it in the presence of one or more alkaline metal oxides (e.g., beryllium oxide, calcium oxide, magnesium oxide, strontium oxide, barium oxide, radium oxide, or any combination thereof; alkaline metal oxides 410 of FIG. 4) to produce one or more fluorinated salts and one or more heated gases. The concentrated source may be treated by a removal system (e.g., furnace 412 of FIG. 4). For example, the halogenated compounds of the concentrated source may be removed by heating the concentrated source in the presence of magnesium oxide, producing magnesium fluoride, water, and carbon dioxide. If the concentration step (i.e., step 504) is omitted, step 506 may be performed directly with the protonated source instead of the concentrated source.

The foregoing description sets forth exemplary systems, methods, techniques, parameters, and the like. It should be recognized, however, that such description is not intended as a limitation on the scope of the present disclosure but is instead provided as a description of exemplary embodiments.

Although the description herein uses terms first, second, etc. to describe various elements, these elements should not be limited by the terms. These terms are only used to distinguish one element from another. For any of the structural and functional characteristics described herein, methods of determining these characteristics are known in the art.

1. A method for removing halogenated compounds from a contaminated source, the method comprising:
concentrating one or more halogenated compounds of the contaminated source to achieve a concentrated source having a greater wt. % of halogenated compounds than the contaminated source; and
removing the one or more halogenated compounds of the concentrated source by heating the concentrated source in the presence of beryllium oxide, magnesium oxide, strontium oxide, barium oxide, radium oxide, or any combination thereof to produce one or more fluorinated salts and one or more heated gases.

2. The method of claim 1, wherein the contaminated source is a liquid source or a gaseous source.

3. The method of claim 2, wherein concentrating the one or more halogenated compounds of the contaminated source to achieve the concentrated source occurs in a continuous reactor.

4. The method of claim 1, wherein the contaminated source is a solid source.

5. The method of claim 4, wherein concentrating the one or more halogenated compounds of the contaminated source to achieve the concentrated source occurs in a batch reactor.

6. The method of claim 1, wherein the one or more halogenated compounds comprise per- and polyfluoroalkyl substances (PFAS), ethylene dibromide, chlorinated ethenes, chlorinated ethanes, halogenated methanes, freons, semi-volatile organic compounds, or any combination thereof.

7. The method of claim 1, wherein concentrating the one or more halogenated compounds of the contaminated source comprises exposing the contaminated source to an ion exchange column comprising resin, granular activated carbons, absorbent compounds, or any combination thereof.

8. The method of claim 1, wherein the concentrated source has greater than or equal to 0.01 wt. % halogenated compounds.

9. The method of claim 1, wherein removing the one or more halogenated compounds of the concentrated source comprises heating the concentrated source to 200-900 degrees Celsius.

10. The method of claim 1, wherein the one or more fluorinated salts comprise beryllium fluoride, magnesium fluoride, strontium fluoride, barium fluoride, radium fluoride, or any combination thereof.

11. The method of claim 1, wherein the one or more heated gases comprise water vapor, nitrogen, carbon dioxide, or any combination thereof.

12. The method of claim 1, further comprising: heating the one or more halogenated compounds of the contaminated source with heat energy from the one or more heated gases.

13. The method of claim 1, further comprising: removing waste residues produced while heating the concentrated source.

14. The method of claim 13, wherein the waste residues comprise non-volatilized halogenated compounds, heavy organic molecules, salts, or any combination thereof.

15. A system for removing halogenated compounds from a contaminated source, the system comprising:
a concentration system comprising an inlet contaminated source comprising one or more halogenated compounds and an outlet concentrated source comprising the one or more halogenated compounds, wherein the outlet concentrated source has a halogenated compound concentration greater than that of the inlet contaminated source; and
a furnace configured to receive the outlet concentrated source and heat the one or more halogenated compounds of the outlet concentrated source in the presence of beryllium oxide, magnesium oxide, strontium oxide, barium oxide, radium oxide, or any combination thereof to remove the one or more halogenated compounds and produce one or more fluorinated salts and one or more heated gases.

16. The system of claim 15, wherein the contaminated source is a liquid source or a gaseous source.

17. The system of claim 16, wherein the concentration system comprises a continuous reactor for heating the inlet contaminated source.

18. The system of claim 15, wherein the contaminated source is a solid source.

19. The method of claim 18, wherein the concentration system comprises a batch reactor for heating the inlet contaminated source.

20. The system of claim 15, wherein the one or more halogenated compounds comprises per-and polyfluoroalkyl substances (PFAS), ethylene dibromide, chlorinated ethenes, chlorinated ethanes, halogenated methanes, freons, semi-volatile organic compounds, or any combination thereof.

21. The system of claim 15, wherein the concentration system comprises an ion exchange column comprising resin, granular activated carbons, absorbent compounds, or any combination thereof.

22. The system of claim 15, wherein the concentrated source has greater than or equal to 0.01 wt. % halogenated compounds.

23. The system of claim 15, wherein the furnace is configured to heat the protonated source to 200-900 degrees Celsius.

24. The system of claim 15, wherein the one or more fluorinated salts comprise beryllium fluoride, magnesium fluoride, strontium fluoride, barium fluoride, radium fluoride, or any combination thereof.

25. The system of claim 15, wherein the one or more heated gases comprise water vapor, nitrogen, carbon dioxide, or any combination thereof.

26. The system of claim 15, wherein the concentration system is configured to receive heat energy from the one or more heated gases from the furnace.

27. The system of claim 15, further comprising: a door for collecting and removing waste residues produced while heating the concentrated source.

28. The system of claim 27, wherein the waste residues comprise non-volatilized halogenated compounds, heavy organic molecules, salts, or any combination thereof.

29. A method for removing halogenated compounds from a contaminated source, the method comprising:
acidifying the one or more halogenated compounds of the contaminated source with an acid to achieve a protonated source having a pH less than 7; and
removing the one or more halogenated compounds of the protonated source by heating the protonated source in the presence of one or more alkaline earth metal oxides to produce one or more fluorinated salts and one or more heated gases.

30. The method of claim 29, wherein the protonated source has a pH of 6-6.5.

31. The method of claim 29, wherein acidifying the one or more halogenated compounds comprises exposing the contaminated source to a gaseous supply of the acid.

32. The method of claim 29, wherein the acid comprises hydrochloric acid, nitric acid, or any combination thereof.

33. A system for removing halogenated compounds from a contaminated source, the system comprising:
an acidification system configured to receive the contaminated source and acidify the one or more halogenated compounds of the contaminated source with an acid to produce a protonated source comprising the one or more halogenated compounds, wherein the protonated source has a pH less than that of the outlet concentrated source; and
a furnace configured to receive the protonated source and heat the one or more halogenated compounds of the protonated source in the presence of one or more alkaline earth metal oxides to remove the one or more halogenated compounds and produce one or more fluorinated salts and one or more heated gases.

34. The system of claim 33, wherein the acidification system further comprises:
a tank for storing the acid;
a pump for transporting the acid into a mixing chamber;
a feed line for routing the acid from the tank into the pump; and
an agitator for mixing the acid with the halogenated compounds of the contaminated source in the mixing chamber.

35. The system of claim 33, wherein the protonated source has a pH of 6-6.5.

36. The system of claim 33, wherein the acidification system is configured to expose the contaminated source to a gaseous supply of the acid.

37. The system of claim 33, wherein the acid comprises hydrochloric acid, nitric acid, or any combination thereof.
